(19) United States
(12) Patent Application Publication
(10) Pub. No.: US 2022/0386561 A1
(43) Pub. Date: Dec. 8, 2022

(54) Feeding Device for Pets

(71) Applicant: Chengying Yu, Xiaogan (CN)

(72) Inventor: Chengying Yu, Xiaogan (CN)

(21) Appl. No.: 17/359,628

(22) Filed: Jun. 27, 2021

(30) Foreign Application Priority Data
Jun. 7, 2021 (CN) 202121264649.6

(51) Int. Cl. A01K 5/01

(52) U.S. Cl. CPC A01K 5/0135

(57) ABSTRACT

The present application relates to a feeding device for pets, comprising a base on which at least one feeding bowl is arranged, and at least one supporting assembly that is rotatably connected to the base and is capable of being rotatably expanded and folded and retracted relative to the base, and a rotation limiting structure between the base and the supporting assembly, wherein the rotation limiting structure comprises a mounting seat on the base, a toothed rack fixed in the mounting seat, and a rotation limiting gear that is synchronously rotatably connected to a rotating shaft of the supporting assembly, and the rotation limiting gear meshes with the toothed rack when the rotating shaft of the supporting assembly is rotatably installed in the mounting seat. With the feeding device for pets according to the present application, the pets can easily enjoy food.

### CROSS-REFERENCE TO RELATED APPLICATIONS

The present application claims the benefit of Chinese Patent Application No. 202121264649.6 filed on Jun. 7, 2021. All the above are hereby incorporated by reference.

### FIELD

The present application generally relates to pet supplies, more particularly to a feeding device for pets.

### BACKGROUND

With improvement of living standards, many families have pets, such as cats and dogs. When a pet owner feeds the pet, pet food is usually placed in a feeding bowl for the pet to eat.

Ordinary feeding bowls for pets are fixed and horizontal positioned, but pets have different sizes and different heights. In the process of pet growth, in order to enable pets to eat scientifically, comfortably and healthily, pet owners must change bowls of different heights many times. Especially for some fast-growing dogs, frequent replacement of bowls of different heights is likely to cause waste. For this reason, a height-adjustable feeding bowl toothed rack for pets has been designed on the market, and a required feeding height is adjusted by a retractable toothed racket. Although this design realizes the height adjustment, the structure is complicated and inconvenient to store. As an improvement, a feeding pan for pets with rotatably foldable supporting legs is designed on the market. The height of the feeding pan can be raised by rotating the supporting legs, and the supporting legs can be folded and retracted to facilitate storage. However, the height adjustment of this design cannot be flexibly changed, and the inclination angle of the feeding pan cannot be adjusted according to the body shape of different pets, which will put a certain pressure on the cervical spine of the pet that eats food, and will affect the physical health of the pet over time.

### SUMMARY

The present application provides a feeding device for pets with flexibly adjustable feeding height and feeding angle in response to the above-mentioned defects of the prior art.

According to one aspect of the present application, a feeding device for pets is provided, comprising a base on which at least one feeding bowl is arranged, and at least one supporting assembly that is rotatably connected to the base and is capable of being rotatably expanded and folded and retracted relative to the base, and a rotation limiting structure that is provided between the base and the supporting assembly, wherein the rotation limiting structure comprises a mounting seat provided on the base, and a toothed rack being fixed in the mounting seat, and the rotation limiting structure further comprises a rotation limiting gear that is synchronously rotatably connected to a rotating shaft of the supporting assembly, and the rotation limiting gear meshes with the toothed rack when the rotating shaft of the supporting assembly is rotatably installed in the mounting seat.

In one embodiment, the rotation limiting structure further comprises a locking block accommodated in the mounting seat and capable of sliding along an axial direction of the rotation limiting gear, and the locking block is provided with an inner toothed hole that meshes with the rotation limiting gear, when the locking block slides to a state that the inner toothed hole meshes with the rotation limiting gear, rotation movement of the rotation limiting gear is restricted, and when the locking block slides to a state that the inner toothed hole is separated from the rotation limiting gear, restriction to the rotation movement of the rotation limiting gear is released.

In one embodiment, a guide post extends in the axial direction from one end of the rotation limiting gear, and an outer diameter of the guide post is smaller than an addendum circle diameter of the inner toothed hole to allow the locking block to slide through.

In one embodiment, at least one guide bar extending in a direction parallel to the axial direction of the rotation limiting gear is provided in the mounting seat, and at least one guide groove being slidingly matched with the at least one guide bar is formed at the bottom of the locking block.

In one embodiment, the locking block is also fixedly connected with an operating slider, and the operating slider is clamped in a corresponding sliding groove on an outer side wall of the mounting seat.

In one embodiment, the supporting assembly comprises two supporting legs symmetrically arranged on both ends of the mounting seat, and the two supporting legs are respectively provided with a rotating shaft at opposite ends thereof; the mounting seat comprises a rotation limiting seat and two pivot supporting seats separately provided on both ends of the rotation limiting seat, and the rotating shafts of the two supporting legs are rotatably supported in the pivot supporting seats respectively and are synchronously rotatably connected to two ends of the rotation limiting gear respectively, and the toothed rack is fixedly arranged in the rotation limiting seat.

In one embodiment, two hexagonal connecting posts extending in the axial direction are provided at the end of the rotating shafts of the two supporting legs respectively, and the two hexagonal connecting posts are inserted into two coaxial inner hexagonal shaft holes formed in two ends of the rotation limiting gear respectively.

In one embodiment, the other end of each of the two supporting legs is provided with an antiskid pad.

In one embodiment, two mounting seats are provided at two opposite sides at the bottom of the base, and the two mounting seats are rotatably connected with two symmetrically arranged supporting assemblies respectively.

In one embodiment, the base is provided with at least one accommodating cavity for accommodating and supporting the at least one feeding bowl.

The feeding device for pets according to embodiments of the present application has the following beneficial effects: the feeding device for pets according to the embodiments of the present application is provided with a synchronously rotatably rotation limiting gear on the supporting assembly to cooperate with the toothed rack fixed on the base. When a certain force is applied to the supporting assembly to make it rotate to a desired angle relative to the base, the meshment of the rotation limiting gear and the toothed rack can restrict the supporting assembly at the adjusted angle. At this time, the supporting assembly supports the base at the desired height, and by changing meshing position between the rotation limiting gear and the toothed rack, flexible adjustments of different heights can realized. In addition, the rotation movement of the rotation limiting gear can be restricted by the locking block to further lock the supporting assembly at the required height. Moreover, by locking the supporting assemblies at two sides of the base to different rotation angles respectively, and the base and the feeding bowls thereon can also be at different inclination angles to meet the feeding needs of pets of different sizes. Therefore, the feeding device for pets according to the embodiments of the present application can flexibly adjust the feeding height according to pets of different heights, and can also adjust the feeding inclination angle according to pets of different body types, so that pets can easily enjoy food.

### BRIEF DESCRIPTION OF THE DRAWINGS

The present application will be further described below in conjunction with accompanying drawings and embodiments. In the accompanying drawings:

FIG. 1 is a structural schematic diagram of a feeding device for pets according to an embodiment of the present application in a state where supporting assemblies are rotated and expanded;

FIG. 2 is a structural schematic diagram of the feeding device for pets shown in FIG. 1 in a state where the supporting assemblies are folded and retracted;

FIG. 3 is a partial exploded structural schematic diagram of a base and the supporting assemblies according to an embodiment of the present application;

FIG. 4 is a structural schematic diagram of a mounting seat according to an embodiment of the present application;

FIG. 5 is a structural schematic diagram of a locking block in cooperation with a rotation limiting gear according to an embodiment of the present application;

FIG. 6 is a structural schematic diagram showing the locking block in different cooperation positions on the rotation limiting gear according to an embodiment of the present application.

### DETAILED DESCRIPTION

In order to make the objectives, technical solutions, and advantages of the present application clearer, the following further describes the present application in detail with reference to the accompanying drawings and embodiments. It should be understood that the specific embodiments described here are only used to explain the present application, and are not used to limit the present application. Moreover, in the case of no conflict, the embodiments in the application and the technical features in the embodiments can be combined with each other.

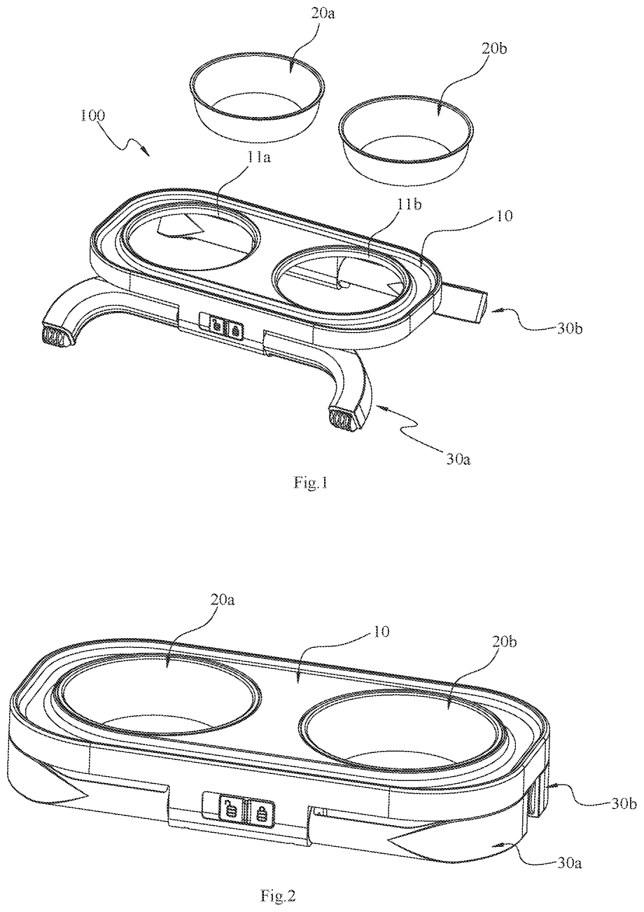

FIG. 1 and FIG. 2 show structural schematic diagrams of a feeding device for pets 100 in different states according to an embodiment of the present application, respectively. As shown in FIGS. 1 and 2, the feeding device for pets 100 comprises a base 10, feeding bowls 20a and 20b, and supporting assemblies 30a and 30b. Through holes 11a and 11b are formed on the base 10. The through holes 11a and 11b pass through the base 10 upper and down to form two accommodating cavities for accommodating and supporting the feeding bowls 20a and 20b. The feeding bowls 20a and 20b are used for holding food. The feeding bowls 20a and 20b are placed in the through holes 11a and 11b respectively for pets to eat food therein. The supporting assemblies 30a and 30b are rotatably connected to two opposite sides at the bottom of the base 10 respectively. The supporting assemblies 30a and 30b can be rotated and expanded relative to the base 10 respectively, so as to support the base 10 to a certain height, as shown in FIG. 1. The supporting assemblies 30a and 30b can also be rotated to be parallel to the bottom of the base 10 respectively, so as to be folded and retracted to the bottom of the base 10, as shown in FIG. 2. Further, a rotation limiting structure is also provided between the base 10 and each of the supporting assemblies 30a and 30b, which is used to limit the supporting assemblies 30a and 30b when the supporting assemblies 30a and 30b rotate to a certain angle with respect to the base 10, so as to keep the base 10 being positioned at an adjusted height. Moreover, by rotating the two supporting assemblies 30a and 30b to different angles relative to the base 10, the base 10 and the feeding bowls 20a and 20b thereon can be positioned at different inclination angles, which is convenient for pets to eat comfortably.

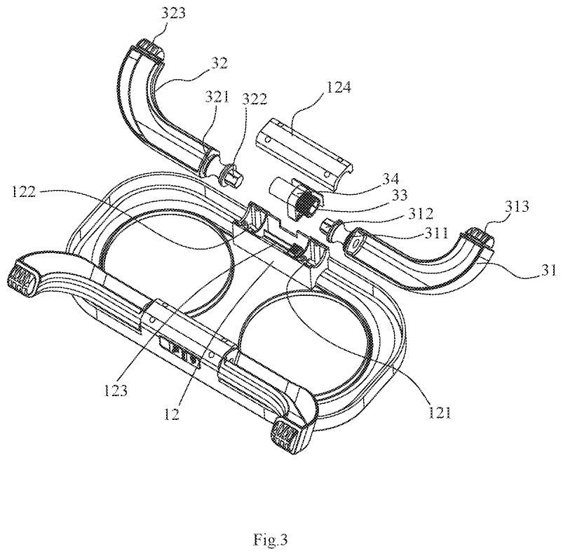

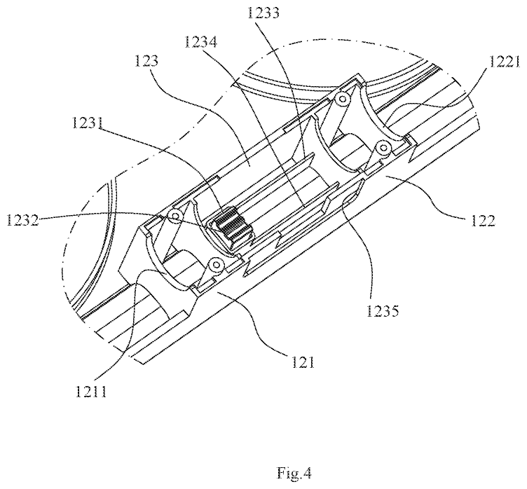

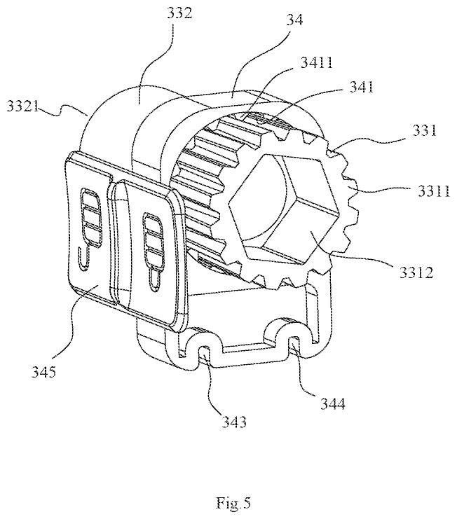

FIG. 3 shows a specific implementation of a rotation limiting structure between the supporting assembly 30a and the base 10 according to an embodiment of the present application. There is also a same rotation limiting structure between the supporting assembly 30b and the base 10, specific implementation of which will not be repeated in the following. As shown in FIG. 3, a mounting seat 12 is provided at the bottom of the base 10 near the side edge, for rotatably mounting the supporting assembly 30a. Specifically, the supporting assembly 30a comprises two supporting legs 31 and 32 symmetrically arranged on both ends of the mounting seat 12. The supporting legs 31 and 32 are substantially L-shaped, and the opposite ends of the supporting legs 31 and 32 are respectively provided with rotating shafts 311 and 321, and hexagonal connecting posts 312 and 322 extend axially at the ends of the rotating shafts 311 and 321, respectively. The other ends of the supporting legs 31 and 32 are also provided with antiskid pads 313 and 323, respectively, to increase friction with the ground. As further shown in FIG. 3 in combination with FIG. 4, the mounting seat 12 comprises a rotation limiting seat 123 and two pivot supporting seats 121 and 122 separately provided on both ends of the rotation limiting seat 123. The pivot supporting seats 121 and 122 are respectively provided with pivot supporting surfaces 1211 and 1221, and the rotating shafts 311 and 321 of the two supporting legs 31 and 32 are rotatably supported on the pivot supporting surfaces 1211 and 1221 of the corresponding pivot supporting seats 121 and 122, respectively. A toothed rack 1231 is fixed in the rotation limiting seat 123 at the end close to the pivot supporting seat 121. The toothed rack 1231 is arranged in a direction perpendicular to the axial direction of the rotating shafts 311 and 321. A plurality of teeth 1232 are formed on an upper surface of the toothed rack 1231. The teeth 1232 extend in a direction parallel to the axial direction of the rotating shafts 311 and 321. A rotation limiting gear 33 and a locking block 34 are accommodated in the rotation limiting seat 123. The rotation limiting gear 33 meshes with the toothed rack 1231, and the locking block 34 is sleeved on the rotation limiting gear 33. The mounting seat 12 is also provided with a mounting cover 124, and the mounting cover 124 is detachably mounted on the mounting seat 12 by means of screws, etc., for enclosing various components in the mounting seat 12 to prevent falling out.

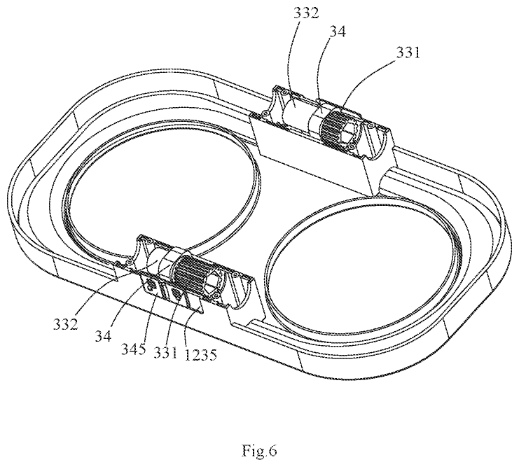

As further shown in FIG. 3 in combination with FIG. 5, the rotation limiting gear 33 comprises a gear segment 331 and a guide post 332 extending from one end of the gear segment 331 in the axial direction. The gear segment 331 is formed with a ring of external teeth 3311 for meshing with the teeth 1232 on the toothed rack 1231. The gear segment 331 is also provided with an inner hexagonal shaft hole 3312 for inserting the hexagonal connecting post 312 provided at the end of the rotating shaft 311 of the supporting leg 31 therein directly, and a synchronous rotation connection of the supporting leg 31 and the rotation limiting gear 33 is realized by a cooperation of the hexagonal connecting post 312 and the inner hexagonal shaft hole 3312. Similarly, the guide post 332 is also provided with an inner hexagonal shaft hole 3321 being coaxial with the hexagonal shaft hole 3312 for inserting the hexagonal connecting post 322 provided at the end of the rotating shaft 321 of the supporting leg 32 therein directly, and a synchronous rotation connection of the supporting leg 32 and the rotation limiting gear 33 is realized by a cooperation of the hexagonal connecting post 322 and the inner hexagonal shaft hole 3321. In this way, when a force is applied to one supporting leg 31 or 32 to make it rotate, it can also act on the other supporting leg 32 or 31 and the rotation limiting gear 33. When the force is large enough, the rotation limiting gear 33 can rotate relative to the toothed rack 1231, so that the supporting assembly 30a rotates relative to the base 10. When the supporting assembly 30a rotates to a desired angle (that is, when the base 10 is raised to a desired height), the meshing relationship between the rotation limiting gear 33 and the toothed rack 1231 can ensure that the two supporting legs 31 and 32 remain at this position. According to different embodiments of the present application, the synchronous rotation connection of the two supporting legs 31 and 32 and the rotation limiting gear 33 can also be implemented in various other possible and suitable manners, and can be further arranged with a fool-proof design to avoid connection angles of the two supporting legs 31 and 32 and the rotation limiting gear 33 are not consistent.

As further shown in FIG. 3 in combination with FIG. 5, the locking block 34 is sleeved on the rotation limiting gear 33. The locking block 34 has a substantially square shape, and an inner toothed hole 341 penetrating both ends of the locking block 34 is formed along the axial direction of the rotation limiting gear 33. The inner toothed hole 341 is provided with inner teeth 3411 meshing with the external teeth 3311 of the gear segment 331. When the locking block 34 is sleeved on the gear segment 331 to achieve meshing, rotation movement of the rotation limiting gear 33 is restricted. When the inner toothed hole 341 of the locking block 34 no longer meshes with the gear segment 331, restriction to the rotation movement of the rotation limiting gear 33 is released. For this reason, an outer diameter of the guide post 332 is designed to be smaller than an addendum circle diameter of the inner toothed hole 341 of the locking block 34 to allow the locking block 34 to slide through and to guide the sliding movement of the locking block 34. Further referring to FIG. 4, there are two guide bars 1233 and 1234 beside the toothed rack 1231 in the rotation limiting seat 123. The two guide bars 1233 and 1234 are spaced apart at a certain distance and extend along a direction parallel to the axial direction of the rotation limiting gear 33. At the same time, as shown in FIG. 5, two guide grooves 343 and 344 are formed at the bottom of the locking block 34. The two guide grooves 343 and 344 are slidingly matched with the two guide bars 1233 and 1234. The locking block 34 is slidably mounted on the two guide bars 1233 and 1234 through the two guide grooves 343 and 344, which can further provide a guiding function for the axial sliding movement of the locking block 34 relative to the rotation limiting gear 33, so as to facilitate the locking block 34 switching between two states of meshing with the gear segment 331 and non-meshing with the gear segment 331. In order to facilitate the operation, the locking block 34 is also fixedly connected with an operating slider 345, which is clamped in a corresponding sliding groove 1235 (see FIG. 4) on the outer side wall of the rotation limiting seat 123 and can move along the sliding groove 1235. FIG. 6 shows a structural schematic diagram of the locking block 34 in different mating positions on the rotation limiting gear 33. In a front mounting seat shown in the figure of FIG. 6, the operating slider 345 is moved to a unlocking side of the sliding groove 1235, and the locking block 34 is driven to slide onto the guide post 332, therefore the inner toothed hole 341 is separated from the gear segment 331 and does not mesh with the gear segment 331, thus the restriction to the rotation movement of the rotation limiting gear 33 by the locking block 34 is released, and a user can adjust the angle of the supporting assemblies respectively at this time. In a rear mounting seat shown in the figure of FIG. 6, the operating slider 345 is moved to a locking side of the sliding groove 1235, and the locking block 34 is driven to slide onto the gear segment 331, therefore the inner toothed hole 341 meshes with the gear segment 331, thus the rotation movement of the rotation limiting gear 33 is restricted by the locking block 34, and height and inclination angle adjusted by the user can be locked.

The feeding device for pets 100 according to the above-mentioned embodiments of the present application can flexibly adjust the feeding height according to pets of different heights, and can also adjust the feeding inclination angle according to pets of different body types, so that the pets can easily enjoy food.

In the feeding device for pets 100 according to the above-mentioned embodiment of the present application, the feeding bowls 20a and 20b is designed being separate from the base 10, and the feeding bowls 20a and 20b are accommodated and supported in the accommodating cavity formed by the through holes 11a and 11b on the base 10. However, the present application is not limited to this. For example, according to other embodiments of the present application, the feeding bowls may also be integrally formed on the base.

The above descriptions are only preferred embodiments of this application, and are not intended to limit this application. Any modification, equivalent replacement and improvement made within the spirit and principle of this application shall be included within the protection scope of this application.

What is claimed is:

1. A feeding device for pets, comprising a base on which at least one feeding bowl is arranged, and at least one supporting assembly that is rotatably connected to the base and is capable of being rotatably expanded and folded and retracted relative to the base, and a rotation limiting structure that is provided between the base and the supporting assembly, wherein the rotation limiting structure comprises a mounting seat provided on the base, and a toothed rack being fixed in the mounting seat, and the rotation limiting structure further comprises a rotation limiting gear that is synchronously rotatably connected to a rotating shaft of the supporting assembly, and the rotation limiting gear meshes with the toothed rack when the rotating shaft of the supporting assembly is rotatably installed in the mounting seat.

2. The feeding device for pets according to claim 1, wherein the rotation limiting structure further comprises a locking block accommodated in the mounting seat and capable of sliding along an axial direction of the rotation limiting gear, and the locking block is provided with an inner toothed hole that meshes with the rotation limiting gear, when the locking block slides to a state that the inner toothed hole meshes with the rotation limiting gear, rotation movement of the rotation limiting gear is restricted, and when the locking block slides to a state that the inner toothed hole is separated from the rotation limiting gear, restriction to the rotation movement of the rotation limiting gear is released.

3. The feeding device for pets according to claim 2, wherein a guide post extends in the axial direction from one end of the rotation limiting gear, and an outer diameter of the guide post is smaller than an addendum circle diameter of the inner toothed hole to allow the locking block to slide through.

4. The feeding device for pets according to claim 2, wherein at least one guide bar extending in a direction parallel to the axial direction of the rotation limiting gear is provided in the mounting seat, and at least one guide groove being slidingly matched with the at least one guide bar is formed at the bottom of the locking block.

5. The feeding device for pets according to claim 2, wherein the locking block is also fixedly connected with an operating slider, and the operating slider is clamped in a corresponding sliding groove on an outer side wall of the mounting seat.

6. The feeding device for pets according to claim 1, wherein the supporting assembly comprises two supporting legs symmetrically arranged on both ends of the mounting seat, and the two supporting legs are respectively provided with a rotating shaft at opposite ends thereof; the mounting seat comprises a rotation limiting seat and two pivot supporting seats separately provided on both ends of the rotation limiting seat, and the rotating shafts of the two supporting legs are rotatably supported in the pivot supporting seats respectively and are synchronously rotatably connected to two ends of the rotation limiting gear respectively, and the toothed rack is fixedly arranged in the rotation limiting seat.

7. The feeding device for pets according to claim 6, wherein two hexagonal connecting posts extending in the axial direction are provided at the end of the rotating shafts of the two supporting legs respectively, and the two hexagonal connecting posts are inserted into two coaxial inner hexagonal shaft holes formed in two ends of the rotation limiting gear respectively.

8. The feeding device for pets according to claim 6, wherein the other end of each of the two supporting legs is provided with an antiskid pad.

9. The feeding device for pets according to claim 1, wherein two mounting seats are provided at two opposite sides at the bottom of the base, and the two mounting seats are rotatably connected with two symmetrically arranged supporting assemblies respectively.

10. The feeding device for pets according to claim 1, wherein the base is provided with at least one accommodating cavity for accommodating and supporting the at least one feeding bowl.
